(19) United States
(12) Patent Application Publication
(10) Pub. No.: US 2008/0229749 A1
(43) Pub. Date: Sep. 25, 2008

(54) Plug in rabbat engine

(76) Inventor: Michel Gamil Rabbat, Holiday, FL (US)

Correspondence Address: MICHEL GAMIL RABBAT, 1042 CORNWALL DR, HOLIDAY, FL, 34691, US

(21) Appl. No.: 12/148,554

(22) Filed: Apr. 21, 2008

Related U.S. Application Data
(63) Continuation-in-part of application No. 11/072,753, filed on Mar. 4, 2005.

(51) Int. Cl. F02C 3/20

(52) U.S. Cl. 60/722

(57) ABSTRACT

By using a plug to charge a medium-sized battery of the most up-to-date technology, the Rabbat PLUG-IN ENGINE benefits from the most up-to-date and most economical available grid supply at any point in time, to start the engine. The Direct Current from the battery sequentially activates an Ultrasound Transducer. The ultrasound waves break down physically electrolyte water into H and OH. The electrolyte carrying H or OH according to whether it is the cathode or the anode, is absorbed into a microfiber substance. The microfiber contains a wire-grid electrode, either anode or cathode. The electrolytic process finally breaks down chemically the partially ionized electrolyte into Hydrogen and Oxygen making use of the H and OH produced by sonic waves The Oxygen produced is passed through an Ionizer. Ionized ambient air, ionized Oxygen, and Hydrogen are injected into and piezzoelectrically sparked in the combustion chamber of a special cored type of gas turbine. The expanding gases rotate the turbine to which a Direct Current generator is attached. The Direct Current is henceforth used to drive electric motors externally and all electric and electronic components internally. It may be used to drive the electric motor driving either the front or rear axle of a car (or both in case of 4-wheel drive), or trucks, trolleys, locomotives, train segments, or compressing air-jets of airplanes, or pod-propellers of boats and ships, for example. Electronic controls regulate the timing and proportions of different gas elements involved.

### BACKGROUND

Petroleum fuels are being used up very fast and their prices are rising at incredible rates despite the efforts of our political leaders to pressure or convince producing countries to increase production output now against those producers own interest. It is in their interest to cap production now and sell at higher prices later. The environment is being affected by CO2 increases in the atmosphere despite having more of it getting dissolved in the seas, oceans and rain.

Hydrogen is a clean-burning fuel but a world-wide grid of pipelines for hydrogen distribution is very costly, time and resources-consuming and potentially hazardous especially in our terrorists-infested times.

We claim that the “Rabbat Plug-in engine” is the solution as it supplies hydrogen on the spot where it is needed whether in a stationary or moveable equipment. It can be small or mammoth-sized to suit any application so long as water is available. It is less wasteful of energy than the 20% to 30% efficiency of present internal combustion vehicles.

The Rabbat Plug-in engine uses available electric grids that use various technologies to which its medium sized battery can be plugged in. It makes use of the advances in medium size batteries which can be charged either at the lowest cost time, or at the more costly point-of-need time. At home or the factory, it will use electricity offered by electric power companies at lower cost at their convenience. Also in case of immediate need, the battery can be charged at service-stations from metered plugs. The ability to replenish a battery from an external grid supply, allows the Rabbat Plug-in engine to do without a starter engine for the electrolytic process. The medium-sized battery starts water electrolysis which in turn supplies the hydrogen and oxygen that explodes to produce rotary movement in a turbine driving an electric generator. The electric generator supplies current to the electric motors driving vehicle wheels or for any other purpose; whenever consumption of current decreases, the excess current is fed back into the battery. The result is a one-speed engine without physical gears for transmission of power and without much waste of energy and fuel every time speed is changed. As in any engine there is loss of energy at every step of energy transformation. The deficit is supplied at intervals by plugging in, or by an emergency electric generator using either liquid or gas fuel.

### SUMMARY OF THE INVENTION

The battery energy deficit is replenished when it is plugged into an electric grid. When the engine is started the plug is automatically disconnected by demagnetizing the area of contact of the plug.

Starting the engine connects the battery to an ultrasonic transducer acting upon the electrolytic solution, producing sonic waves that physically break down H2O (water) into H and OH (please refer to the American Chemical Society publication regarding ultrasound and Sonochemistry).

The electrolytic acidified water now carrying partially dissociated water components, rises up the microfiber sponge-like elements at each pole. Two electrode steel grids are interwoven into the sponge, acting as the anode and the other as the cathode of the electrolytic cell. Little electricity is needed to split the last bond between O and OH.

H2 is formed at the cathode and O2 at the anode. Each gas is pumped into a storage tank. The oxygen is ionized prior to its injection into the turbine combustion chamber. The hydrogen is piezzoelectrically sparked when it is injected into the ionized oxygen and air in the combustion chamber.

The turbine has multiple sets of rotating blades directly connected to the central solid shaft. The first set of blades is connected to a central pipe that allows the explosive gases to pass through and hit the second set of fan blades and the third successively. This action produces the rotating motion that drives the direct current generator attached to the drive shaft. The central pipes of the turbine are connected to the drive shaft.

This engine uses a battery that may be plugged into electricity produced by any form of generation: atomic power, steam, coal, alcohol, methane, wood, hydroelectric, wind, sea-waves, tides etc., and the emergency electric generator.

This engine does neither use cogs nor mechanical axles for transfer of energy. The engine is light when compared to present-day internal combustion engines and their transmission systems or the larger and much heavier batteries of hydrogen fuel-cells. Since engine weight is a major proportion of the load in passenger vehicles, the Rabbat Plug-in engine has that extra efficiency as an advantage.

Electrolytic water may be replenished at any service-stationer bought from supermarkets the way engine oil and drinking water are presently.

We drive the car to a service-station to supply it with electrolyte water and/or some electric extra charge. We turn on the ignition. The magnetic plug disconnects and the electrolysis starts. Stored fuel and oxidizer are injected and sparked. To increase or decrease speed, the quantity of electricity supplied to the combustion, electrolysis, ionization and ultrasound vibration is increased or decreased. It is decreased to slow down. When the ignition is turned off, all electric activity stops instantaneously. When the car is temporarily stopped or slowed, excess electricity produced by this permanent speed engine, feeds into the battery. No waste of energy, of fuel, of heat, of emitted excess gases, of uncombusted fuel. Whenever slowed, excess Hydrogen and Oxygen are stored in the tanks. Whenever accelerated, stored electricity, Hydrogen and Oxygen increase the engine output to produce movement and increased output by the generator in seconds.

### DESCRIPTION

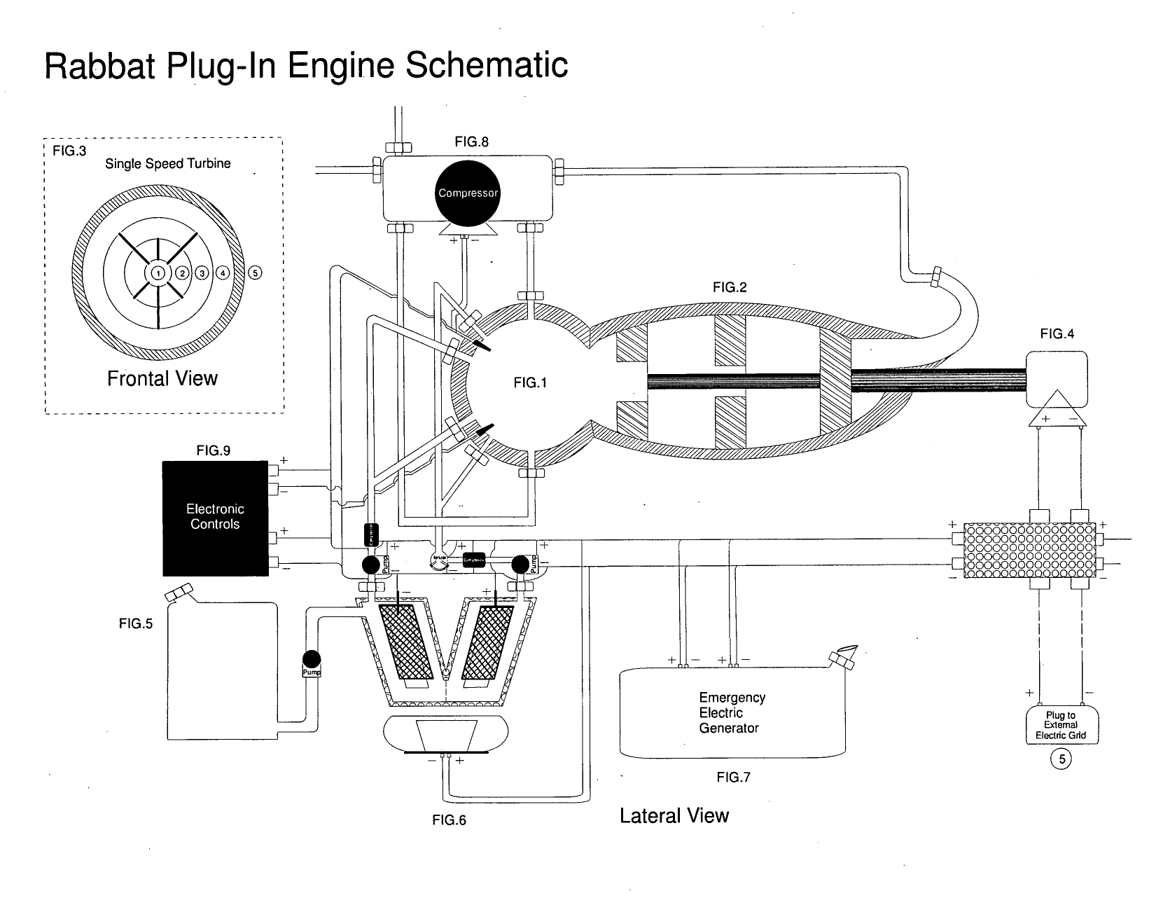

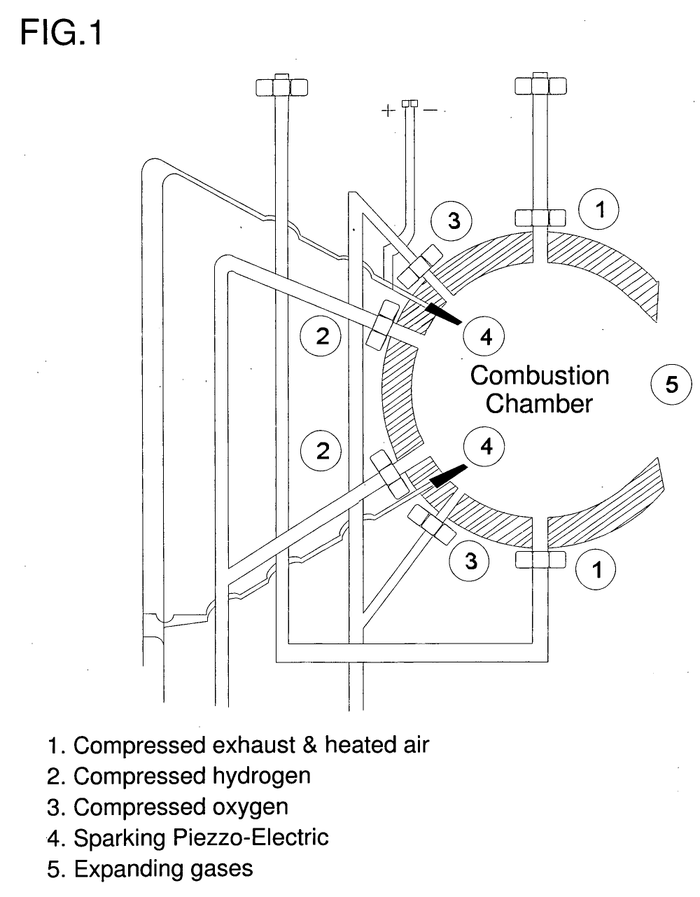

FIG. 1 The main compressor receives hot air that surrounds the engine at work and injects it under appropriate pressure through nozzle (1) into the combustion chamber for the oxidation of the fuel whenever required by the O2 sensors and the electronic controls. Hydrogen is injected through nozzles (2) into the combustion chamber. The electronic controls inject pre-set quantities of ionized O2 through nozzles (3). Ionized hot air is injected into the combustion chamber through nozzles (1).

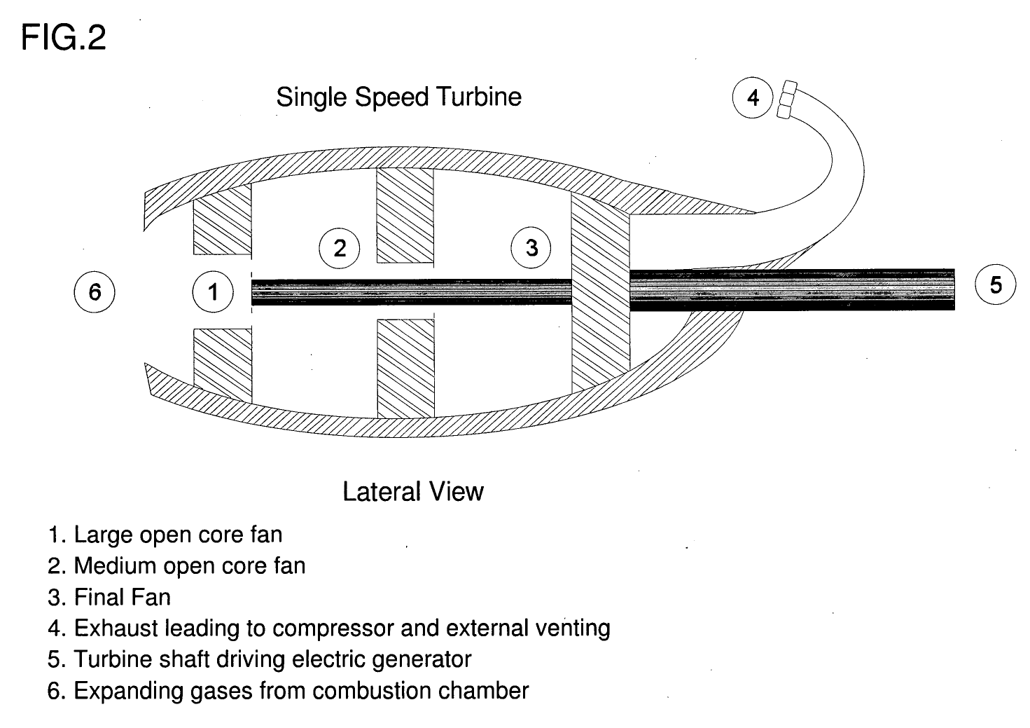

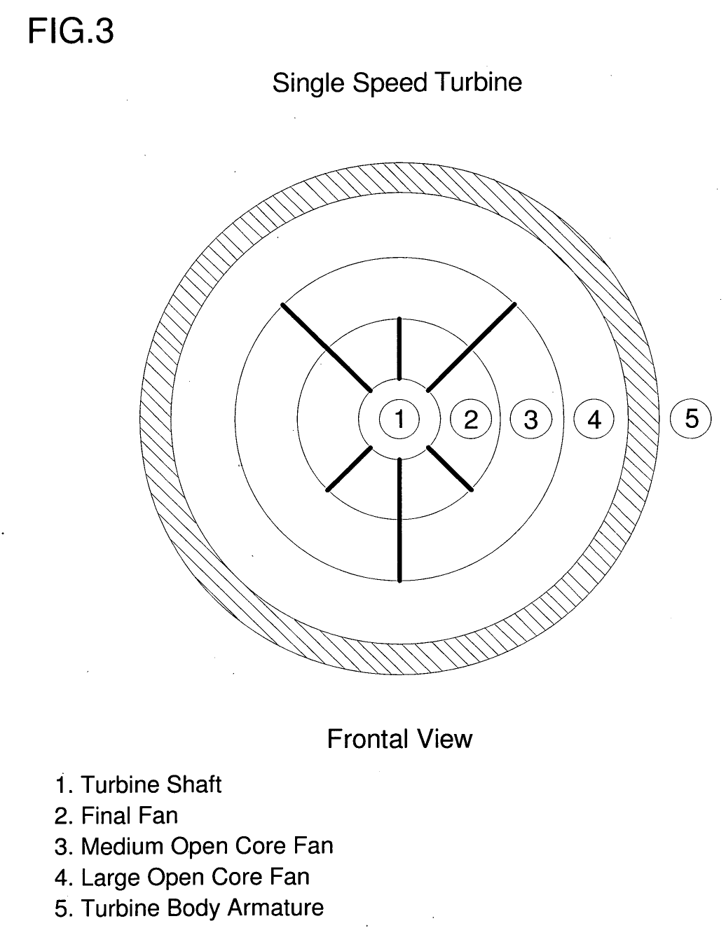

FIG. 2 & FIG. 3 The turbine has three sets of rotating blades, the first two are open at the core, so that the exploding gases from the combustion chamber (6) hit the three sets of blades at once; the first two, peripherally and the last one, frontally. The shaft (5) drives the electric generator. (4) is the exhaust duct leading to the central air compressor.

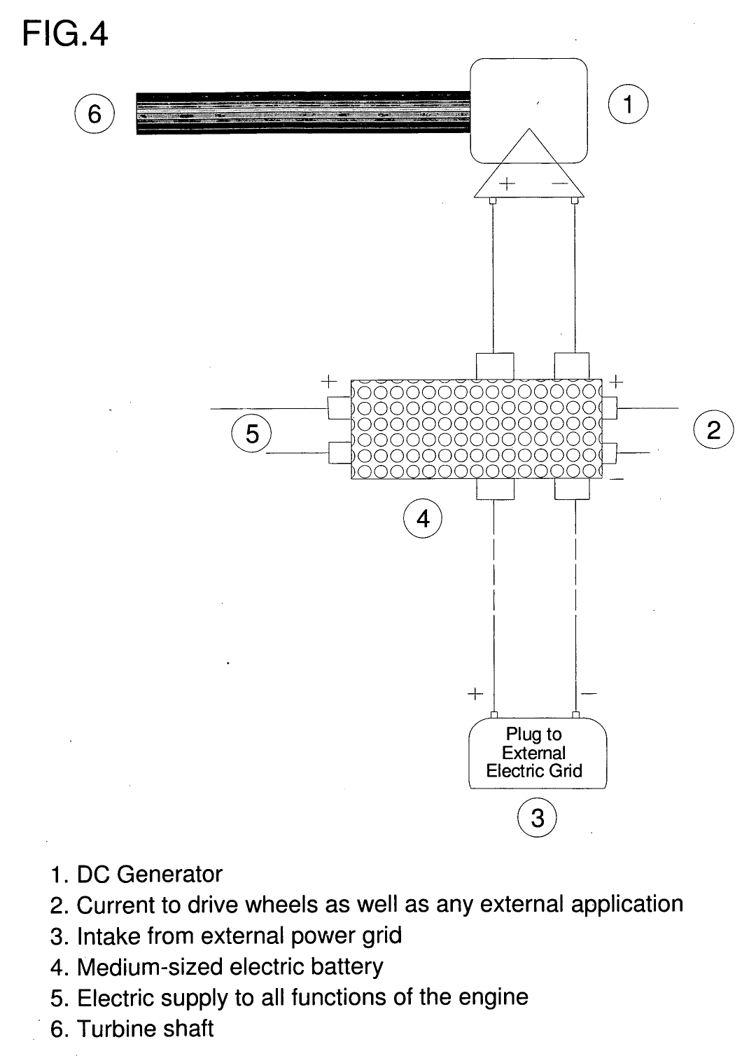

FIG. 4 The magnetic plug (3) magnetically attaches to a socket of the external electric supply grid and supplies electric charging to a medium-sized battery. When the plug is demagnetized the engine is disconnected from the umbilical connection. This disconnection occurs when the ignition key to the engine is turned on. The car can then move off without pulling at the supply socket. Electricity goes to the medium-sized (4) which supplies electricity (2). It supplies electricity to the entire engine and its various parts (5). The battery receives electricity from generator (1).

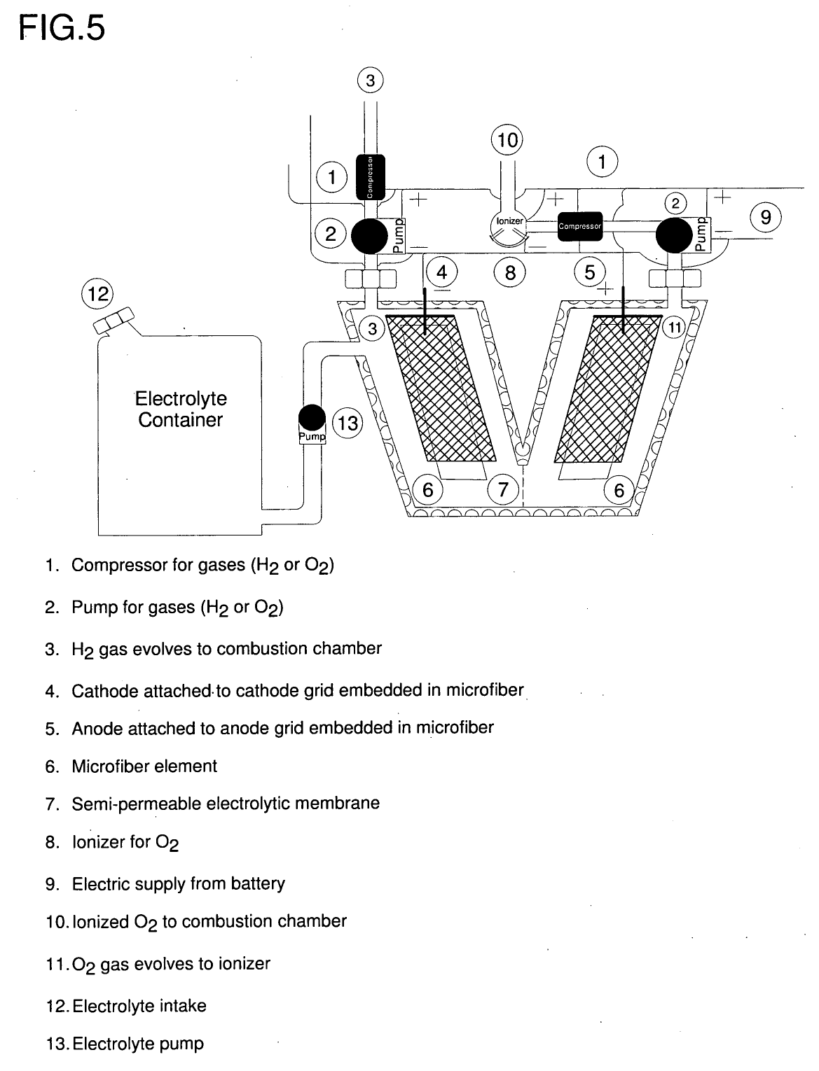

FIG. 5 It is an aqueous electrolysis cell for the generation of hydrogen and oxygen, it is composed of an electrolysis container having an anode chamber and a cathode chamber connecting via an electrolysis membrane. An anode and a cathode having permeability to gas and water are fitted in their respective chambers and are connected to the Direct current through their respective terminals (4 & 5). Wide area grid anode and cathode (6) are connected to each pole. These are tightly embedded into microfiber sleeves that raise the H and OH and electrolytic solution to make contact with the current and produce H2 (3) and O2 (11) respectively. The electrolytic cell must be easy to disconnect and remove for servicing or replacement. Water is slightly acidified with dilute H2SO4 for ionization catalysis. The sonochemically dissociated water molecule requires less electric power to complete electrolysis. A gas compressor pump (2) is fitted to the cathode exit pipe to feed H2 to the combustion chamber. A similar pump (2) is fitted to the anode exit pipe to supply O2 to the combustion chamber. Storage tanks for H2 and O2 and their pumps are in line. O2 passes through an ionizer (10) to make it more reactive, before it is injected into the combustion chamber. (13) Is an electrolyte pump that draws electrolyte from its container to feed the electrolytic cell. A water tank connects to the outside for the refill of water and/or electrolyte (12).

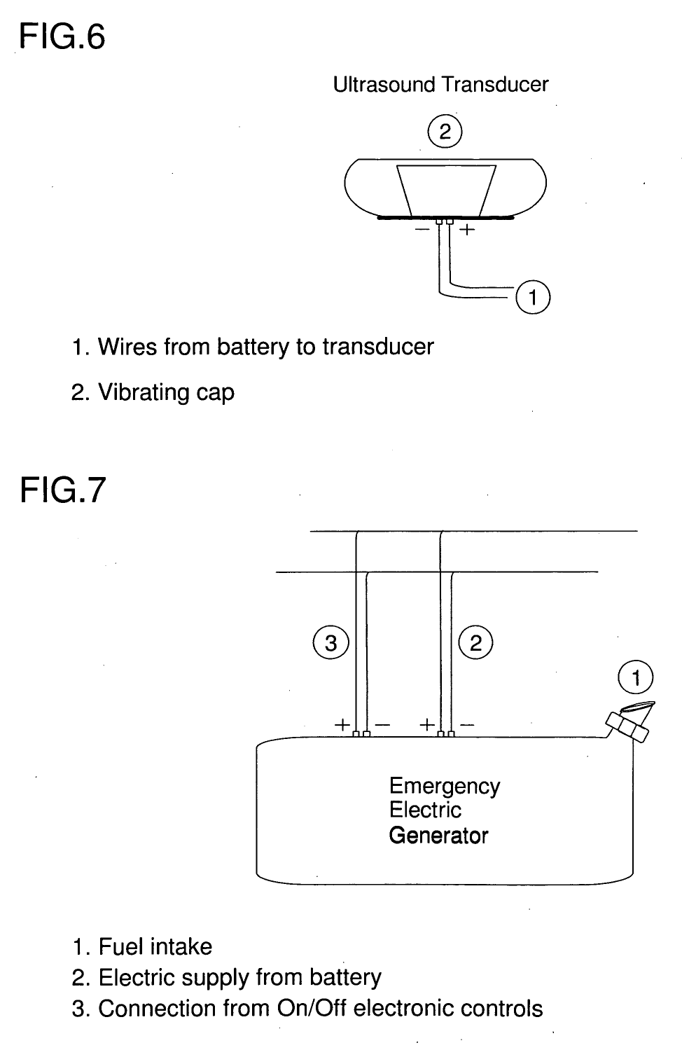

FIG. 6 The ignition sends the right voltage (1) to an ultrasound transducer that produces sonic waves (2) in the electrolytic solution breaking off physically one of the H bonds of H2O at very low electric cost.

FIG. 7 An electric generator provides electricity to the battery in case battery supply is getting low. It can be used to reach the nearest service station or home where the battery can be fully replenished. The heavy duty generator could be used on certain models for long range travel. Fuel can be refilled at (1) whether it is liquid or with special fittings for gases.

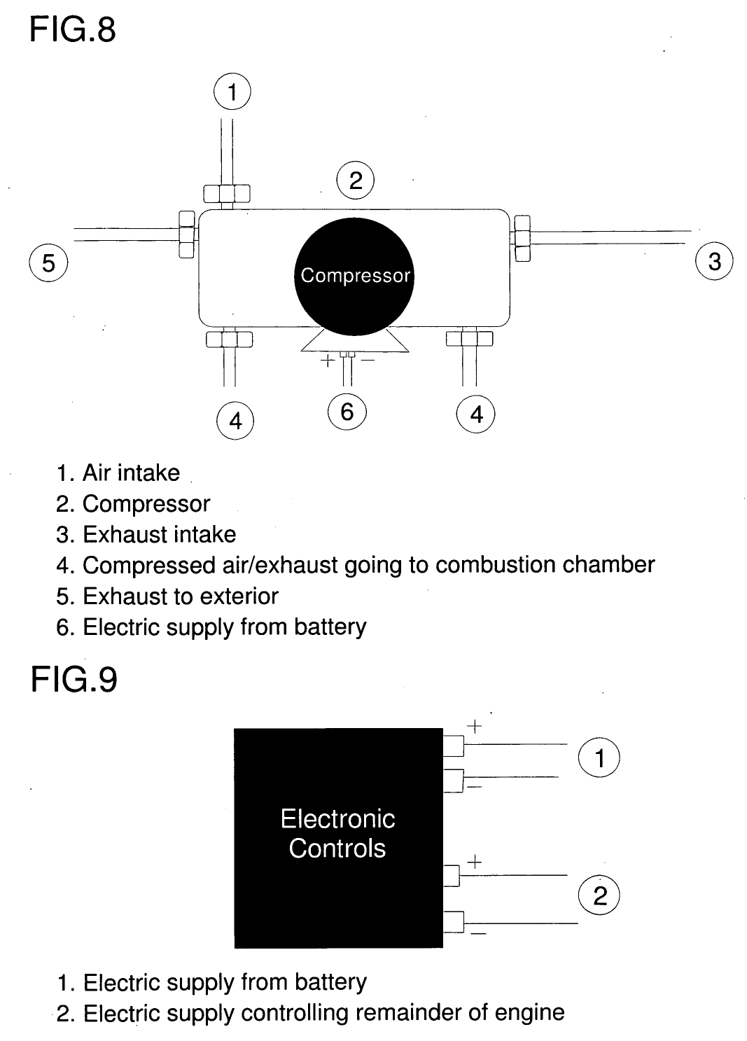

FIG. 8 This is the main compressor (2). The air comes in at (1) and hot exhaust comes in at (3) from the turbine. Both fresh air and exhaust are used to provide extra gases for expansion within the combustion chamber using the heat of the hydrogen and oxygen recombination. These compressed gases (4) go to the combustion chamber. Ionized air, hydrogen and ionized oxygen are injected into the combustion chamber. The explosive gases drive a multiple set of turbine blades to rotate the shaft of a direct current generator. Hot exhaust gases including air components, hydrogen and oxygen are reinjected into the compressor for the recycling of their thermal and chemical energy. Excess gasses are released to the exterior when not needed for the combustion chamber. An exhaust line (5) leaves the compressor with all unused exhaust to the exterior. (6) Supplies the compressor with electricity from the battery via the grid.

FIG. 9 The electronic controls are connected to the electric grid of the engine and to a complex set of sensors and activators. They regulate both quantity of each gas and the timing for its release or cessation. It manages and times every aspect of delivery and combustion.

1. The RABBAT PLUG-IN ENGINE is organized to use electric power from a grid network at the lowest offered cost or at the most convenient cost, to charge a medium-sized electric battery of the most up-to-date technology to supply Direct current to a Sound Transducer acting upon an acidified electrolyte to produce H and OH which are further broken down electrolytically to produce Oxygen that is ionized before its injection, and Hydrogen that is injected together with ionized air and oxygen in the combustion chamber of a special type of gas turbine to provide rotary motion to an electric generator which is henceforth the source of electricity through the battery to its external application such as driving the wheels of a vehicle and internally for use in all segments of the engine.
